(19) United States
(12) Patent Application Publication
(10) Pub. No.: US 2006/0208244 A1
(43) Pub. Date: Sep. 21, 2006

(54) "Wire pullin' genie" apparatus and method for wire pull installations

(76) Inventors: Wayne M. Milone, Alvin, TX (US); Melonie Milone, Alvin, TX (US)

Correspondence Address: ANDREWS & KURTH, L.L.P., 600 TRAVIS, SUITE 4200, HOUSTON, TX, 77002, US

(21) Appl. No.: 11/080,058

(22) Filed: Mar. 15, 2005

(51) Int. Cl. H02G 1/08

(52) U.S. Cl. 254/134.3 FT

(57) ABSTRACT

A wire feed apparatus and method for wire pulling installations through conduit between two boxes. A preferred embodiment of the wire feed apparatus has an opening, preferably centrally located, through which the wires pass prior to entering the box. The apparatus is adapted to securely mount to the box for the pulling operation. Preferably, the apparatus includes mounting apertures or slots to accommodate mounting of the apparatus to boxes of various sizes and shapes. The opening provides wire guidance as the wires enter the box opening and conduit and thus eliminates or significantly reduces the possibility of damaging the wire insulation while also reducing the pulling force required to pull the wires. Preferably, the wire feed apparatus is manufactured from a durable, sturdy plastic material.

### BACKGROUND OF THE INVENTION

1. Field of the Invention

This invention relates to pulling wires through a conduit, and more particularly, to a method and apparatus to assist in feeding the wires into an electrical box to which the conduit is attached.

2. Description of the Related Art

To accomplish the distribution of electricity, insulated electrical wire must be installed between the power source and power distribution box and routed to electrical boxes to supply the required electrical power to a device, such as an electrical outlet or lighting fixture. The size of the wire used is determined by the application and amount of current that will be carried by the wire. The size of wires or electrical conductors is expressed in either circular mils or more typically by a numbering system known as the American Wire Gage System. In the American Wire Gage System, the smaller the number the larger the wire diameter and vice-versa.

In many instances, municipal codes require that electrical wires in buildings be routed through a pipe, typically referred to as conduit. Thus, electrical wires spanning between electrical boxes are contained in conduit attached to the electrical boxes. Electricians and technicians are routinely required to pull wires or cables through conduit extending between electrical boxes. It is not uncommon for such conduits to span several feet in length and contain one or more elbows and turns which increases the difficulty of pulling wires through the conduits. The conduit is hidden behind walls and above the ceiling in buildings. A device that is commonly used to pull wiring through conduit is referred to as a fish tape. One example of a fish tape is shown and described in U.S. Pat. No. 6,416,040, which is herein incorporated by reference in its entirety.

A typical technique for pulling wires through a conduit entails initially pushing a length of resilient spring steel fish tape, wound on a reel, through an electrical box opening and the attached conduit. This initial location where the fish tape is initially inserted into the box is referred to as the “pull end.” The fish tape typically has a substantially rectangular cross-section which, in combination with its spring steel construction, allows it to bend around corners within the conduit while maintaining sufficient rigidity to be pushed a considerable distance. A flexible leader with a rounded tip is attached to a free end of the fish tape. The leader enhances the ability to negotiate comers as the fish tape is pushed through the conduit.

After the leader reaches the terminal end of the conduit and the attached electrical box, referred to as the “feed end,” the required number and size of electrical wires are attached to the leader. The number and size of wires required depends on the specific application. The diameter of the conduit is sized to accommodate the required wires. For example, a conduit having a 1″ diameter can contain approximately 20 individual wires of a particular gauge whereas a ½″ diameter conduit can only accommodate 9 such wires. The fish tape and attached wires are then pulled back through the conduit until the leader and the end of the electrical wires exit the end of the conduit and the box at the pull end.

It is very important that the insulation on the wires not be damaged during the pulling operation. Damage to the insulation can result as the wire passes through the box opening at the feed end. For example, the wires are typically pulled off of individual reels at a location proximate the feed end. The box may be mounted in the ceiling with the wire reels supported on the floor below and the conduit horizontally connected to the box. In this example, one can envision that during the pulling operation, the wires will come off the floor supported reels traveling upwardly to the ceiling before transitioning horizontally into the box opening and conduit. The potential exists for a burr or a sharp or abrupt edge of the box, particularly at the box opening leading to the conduit, to damage the integrity of the insulation. Rarely, if ever, will the wires be directly aligned with the box opening. This is unlikely to occur due to the plurality of wires that are typically being simultaneously pulled since each of the wires is stored on a separate reel and all wires converge in a box or conduit opening of approximately 1″ or less.

At least partially due to the aforementioned problems, pulling the wires is generally a two person job. Typically, when pulling the wires, one person pulls the fish tape from the pull end while a second person at the feed end feeds the electrical wires into the second box at the other end of the conduit. Typically, the fish tape and the wires are pulled in increments or strokes of several feet at a time. The two people at the opposite ends of the conduit develop a rhythm which allows them to pull and feed wire at the same time, and this rhythm enhances the speed and ease by which the wire is pulled. As described, the wire pulling installation requires two persons consuming much time and manpower which translates into higher costs.

It is desirable to optimize the wire pulling installation by reducing costs. It is also desirable to optimize the wire pulling installation by reducing the manpower required.

### BRIEF SUMMARY OF THE INVENTION

The present invention is a wire feed apparatus, known as a “Wire Pullin' Genie”, and method adapted to assist in the wire pulling installation. The wire feed apparatus is designed for mounting to a box, typically an electrical box, at the feed end of the pull. Preferably, The wire feed apparatus is used in conjunction with a fish tape when pulling electrical wires. The present invention allows the installation to be performed by single person, thus eliminating the need for a second person.

In a preferred embodiment, the wire feed apparatus has an opening, preferably centrally located, through which the wires pass prior to entering the box. The apparatus is adapted to securely mount to the box for the pulling operation. Preferably, the apparatus includes mounting apertures or slots to accommodate mounting of the apparatus to boxes of various sizes and shapes. The opening provides wire guidance as the wires enter the box opening and conduit and thus eliminates or significantly reduces the possibility of damaging the wire insulation while also reducing the pulling force required to pull the wires. Preferably, the wire feed apparatus is manufactured from a durable, sturdy plastic material.

The wire feed apparatus is easily and quickly attached to a box at the feed end. Preferably, after mounting the wire feed apparatus to the box, a fish tape is run from the pull end to the box at the feed end. At the feed end, the end of the fish tape is extended through the opening of the wire feed apparatus and the wires to be installed are attached to the fish tape end. The wires are preferably stored on reels that are rotatably supported. The installer returns to the pull end and retrieves the fish tape which pulls the fish tape end with attached wires through the wire feed apparatus opening and box and into and through the conduit and finally through the box at the pull end. The fish tape is detached and a sufficient length of wires are left extending from the boxes at each end.

### BRIEF DESCRIPTION OF THE SEVERAL VIEWS OF THE DRAWINGS

The objects, advantages and features of the invention will become more apparent by reference to the drawings which are appended hereto and wherein like numerals indicate like parts and wherein illustrated embodiments of the invention are shown, in which:

FIG. 1 is a view of two boxes interconnected by piping or conduit;

FIG. 2 is an enlarged view taken along lines 2-2 of FIG. 1;

FIG. 3 is a perspective view of a preferred embodiment of the wire feed apparatus;

FIG. 4 is a plan view of the wire feed apparatus of FIG. 3;

FIG. 5 is a view taken along lines 5-5 of FIG. 4;

FIG. 6 is an elevation view of the preferred embodiment of the wire feed apparatus mounted to a box;

FIG. 7 is a view taken along lines 7-7 of FIG. 6;

FIG. 8 is a plan view of a second embodiment of the wire feed apparatus according to the present invention;

FIG. 9 is a plan view of a third embodiment of the wire feed apparatus according to the present invention;

FIG. 10 is a section view of another embodiment of the wire feed apparatus according to the present invention shown mounted to a box with wires being pulled;

FIG. 11 is a plan view of yet another embodiment of the wire feed apparatus according to the present invention; and

FIG. 12 is a view of an embodiment of the wire feed apparatus of the present invention mounted to a box during a wire pull installation.

### DETAILED DESCRIPTION OF THE INVENTION

A description of the wire feed apparatus of the present invention, generally referenced by numeral 30, and the method of using the wire feed apparatus 30 will be described in detail with reference to the drawings.

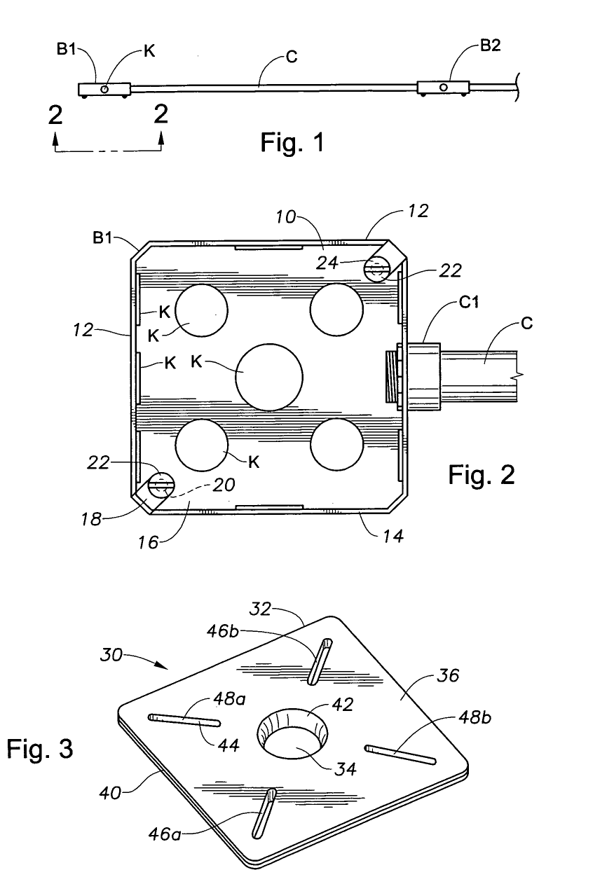

FIG. 1 illustrates in simplistic detail a first box B1 connected to a second box B2 with a string of piping C, typically conduit. The depiction of FIG. 1 could be representative of two electrical boxes mounted in a ceiling for mounting light fixtures through which the electrical wiring must be installed in the conduit. Since boxes are available in many shapes and sizes, it is to be understood that boxes will generally be referred to as “box B.”

As shown in FIG. 2, the box B1 is a generally rectangular box having a plurality of “knockouts” K which are adapted to be removed or “knocked out” when desired to attach a conduit to the box from any of a variety of directions. In FIG. 2, a knockout has been removed to allow the conduit C to be attached to the box B1, typically with a connector C1.

It is to be understood that the box B1 and connector C1 are merely for illustrative purposes and are not intended to limit the scope of the invention. Box B1 comes in a variety of sizes, shapes and arrangements. For example, some boxes are round. There are boxes having various arrangements and sizes of knockouts K. Additionally, there are several different types of commercially available connectors C1. The various boxes and connectors are well known by a person of ordinary skill in the art.

Still referring to FIG. 2, the box B1 typically includes a back wall 10 and a peripheral side wall or walls 12 extending from the periphery of the back wall 10. The side walls 12 terminate at an edge 14 defining a box opening 16. One or more tabs 18 typically extend from the peripheral walls 12. The tabs 18 typically include a threaded hole 20 adapted to threadedly engage a threaded member 22, typically a screw.

Referring to FIGS. 3-5, a preferred embodiment of the wire feed apparatus 30 is shown. The wire feed apparatus 30 preferably includes a plate-like member 32 having an opening 34, preferably circular, extending through the member 32. The opening 34 is preferably centrally located in the member 32. The circular opening 34 preferably has a diameter in the range of 0.5″ to 2″, more preferably in the range of 1.0″ to 1.75″, and most preferably in the range of 1.25″ to 1.5″.

As shown in FIG. 5, the member 32 has a first surface 36 and a second surface 38. The first and second surfaces 36 and 38 may be planer and parallel to each other. It may be desirable, depending on the type of material used, to have the thickness of the wire feed apparatus 30 increase from a peripheral edge 40 towards the center of the wire feed apparatus 30. In the preferred embodiment shown in FIG. 5, the second surface 38 is planer and the first surface 36 tapers away from the second surface from the peripheral edge 40 of the member 32 to the central opening 34. In a preferred embodiment the thickness is approximately 0.25″ at the peripheral edge 40 and increases to a thickness of approximately 0.50″ at the wall 42 defining the central opening 34.

The member 32 has a wall 42, preferably rounded or arcuate, from the first surface 36 to the second surface 38 defining the opening 34. Preferably, the rounded wall 42 is smooth to avoid any sharp or blunt edges that could possibly damage the wire insulation as it passes through the opening 34 during the wire pulling and installation process. Preferably, the opening has a height of at least 0.2″.

Since there are many different sizes and shapes of electrical boxes, the wire feed apparatus 30 could be made in several different sizes and shapes to accommodate each of the various boxes. However, this is neither preferable nor desirable. Preferably, the wire feed apparatus 30 is made so that one apparatus works with various sizes and shapes of boxes. In one preferred embodiment, the wire feed apparatus 30 is generally square in shape with each side measuring approximately 5.625″ in length.

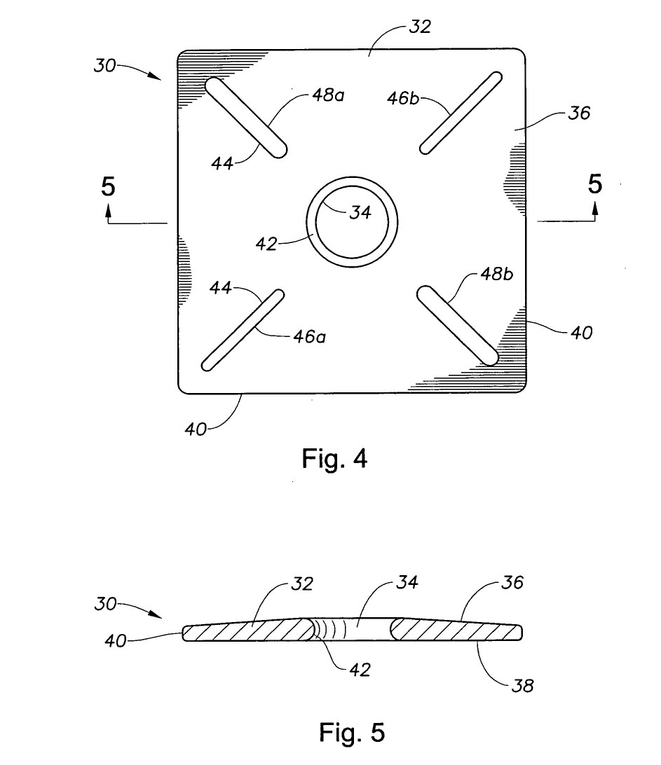

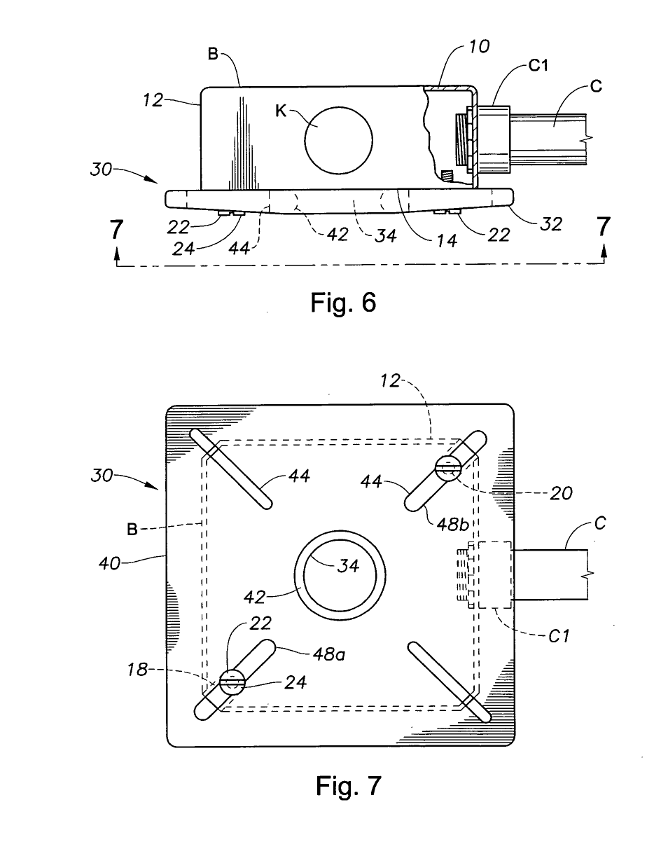

As shown in FIG. 4, the preferred embodiment of the wire feed apparatus 30 includes one or more mounting apertures 44, preferably extending through the plate-like member 32. The mounting aperture 44 is adapted to receive a screw 22 of the box B such that the wire feed apparatus 30 can be secured to the box B by the threaded engagement of the screw 22 and the threaded hole 20 as shown in FIGS. 6 and 7. The preferred embodiment of the wire feed apparatus 30 includes at least two mounting apertures 44, one mounting aperture 44 for each screw 22 as boxes B typically include two screws 22. Referring to FIG. 4, the preferred embodiment includes mounting apertures 46a and 46b and mounting apertures 48a and 48b. It is to be understood that mounting apertures 48a and 48b are optional for reasons explained below.

The mounting apertures 46a, 46b, 48a and 48b are shown as slots in the preferred embodiment of FIG. 4. The slots 46a and 46b are preferably adapted to accommodate the screw size of the box B. The slots 46a, 46b have a width greater than the screw diameter but less than the diameter of the screw head 24. In the embodiment shown in FIG. 4, the slots 46a, 46b are preferably elongated and axially aligned with each other. In a preferred embodiment, each elongated slot 46a, 46b has a length of approximately 1.0″ to 1.5″. Preferably, the center of the opening 34 intersects the axis of the elongated slots 46a, 46b. The elongated slots 46a, 46b allow the wire feed apparatus 30 to be mounted to a variety of sizes and shapes of boxes B having a screw spacing falling within the spacing range provided by the opposing slots 46a and 46b.

The mounting apertures 48a and 48b are shown in FIG. 4 as elongated slots having a width slightly greater than the width of the slots 46a, 46b. The elongated slots 48a and 48b are adapted to accommodate screws having a diameter larger than the width of the elongated slots 46a, 46b.

Referring to FIGS. 6 and 7, the wire feed apparatus 30 is shown mounted to a box B. In this embodiment, the screws 22 are first removed from the box B, and after positioning the wire feed apparatus 30 on the box B, the screws 22 are inserted through the mounting apertures 48a, 48b and threaded into the threaded hole 20 until the screw heads 24 firmly engage and secure the wire feed apparatus 30 in place, preferably centraliy over the box opening 16.

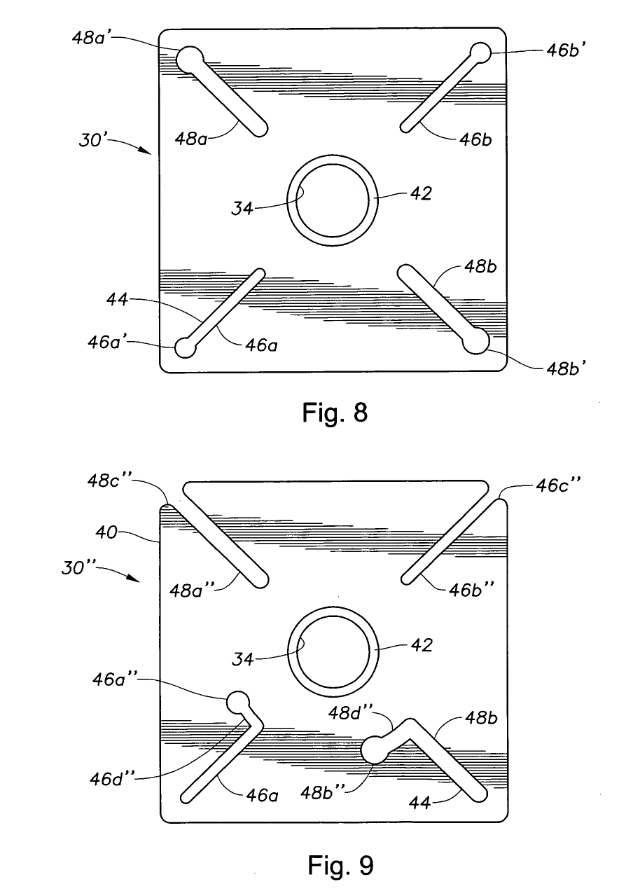

Referring to FIG. 8, a second embodiment of the wire feed apparatus, referred to as 30′, is shown having an enlarged portion 46a′, 46b′, 48a′ and 48b′ at one of the ends of the elongated slots 46a, 46b, 48a and 48b, respectively. The enlarged portion 46a′, 46b′, 48a′ and 48b′ is larger than the head 24 of the screw 22 adapted to be received in the mounting aperture 44. The wire feed apparatus 30′ is adapted to be mounted to a box B without removing the screws 22 from the box B. With the screws 22 threadedly retained to a position such that the heads 24 are at a distance from the tabs 18 greater than the thickness of the wire feed apparatus 30′ at the enlarged portion, one enlarged portion, such as 46a′, is positioned over one screw head 24 and the member 32 is moved towards the box B such that the one screw head 24 extends through the corresponding enlarged portion 46a′. The wire feed apparatus 30′ is then positioned so that the second screw head can be extended through the enlarged portion 46b′. It is to be understood that while the wire feed apparatus 30′ is positioned so that the enlarged portion 46b′ is over the second screw head 24, the first screw 22 is received and maintained in the elongated slot 46a by the first screw head 24 being larger than the width of the elongated slot 46a. The wire feed apparatus 30′ is preferably substantially centered over the box openingl6 before tightening the screws 22 to firmly secure the wire feed apparatus 30′ to the box B.

Referring to FIG. 9, a third embodiment of the wire feed apparatus, referred to as 30′, is shown having an enlarged portion 46a″ and 48b″ joined to the elongated slots 46a and 48b, respectively. The enlarged portion 48b″, 46a″ is shown joined to the elongated slot 48b, 46a, respectively, via a short slot 48d″, 46d″, respectively. The enlarged portion 46a″, 48b is larger than the head 24 of the screw 22 adapted to be received in the mounting aperture 44. Mounting apertures 48a″ and 46b″ are elongated openings having a mouth 48c″ and 46c″, respectively, formed at the peripheral edge 40 of the member 32 of the wire feed apparatus 30″. The wire feed apparatus 30″ is adapted to be mounted to a box B without removing the screws 22 from the box B. With the screws 22 threadedly retained to a position sufficient to receive the required thickness of the member 32, the wire feed apparatus 30″ is positioned so that a mouth, such as 48c″, receives one screw 22 in the elongated opening 48a″. While maintaining the first screw 22 in the elongated opening 48a″, the wire feed apparatus 30″ is then positioned so that the second screw head 24 can be extended through the enlarged portion 48b″. Preferably, the member 32 is moved such that the second screw 22 travels through the short slot 48d″ and into the elongated slot 48b. The wire feed apparatus 30″ is then preferably substantially centered over the box opening 16 before tightening the screws 22 to firmly secure the wire feed apparatus 30″ to the box B.

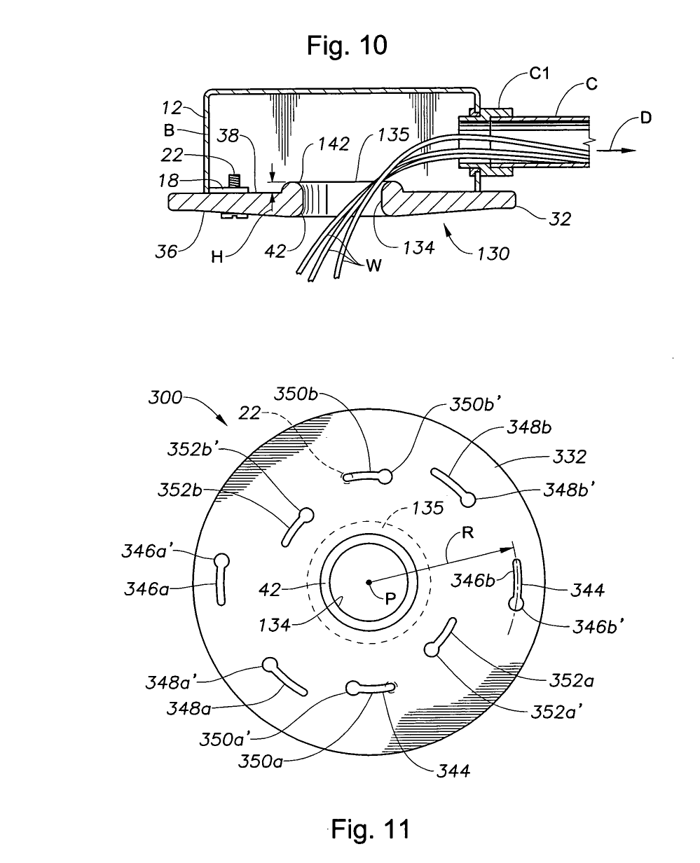

FIG. 10 is an alternative embodiment of the wire feed apparatus, referred to as 130. The wire feed apparatus 130 is similar to the other embodiments of the wire feed apparatus 30, 30′ and 30″ and includes a feature that can be incorporated with any of the embodiments according to the present invention. The wire feed apparatus 130 has an opening 134, preferably circular, extending through the plate-like member 32. The opening 134, preferably centrally located in the member 32, preferably has a diameter in the range of 0.5″ to 2″, more preferably in the range of 1.0″ to 1.75″, and most preferably in the range of 1.25″ to 1.5″. The second surface 38 of the member 32 preferably includes an extending portion 135 extending from the perimeter of the opening 134. Preferably, the extending portion 135 has a height H which extends into the box opening 16. Preferably, the extending portion extends into the box opening 16 at least 0.25″ and more preferably in the range of 0.25″ to 0.75″. In the embodiment shown in FIG. 10, the extending portion 135 is continuous around the circular opening 134 and extends the height of the opening 134. Preferably, the extending portion 135 has a rounded or arcuate portion 142 defining the opening 134 and the opening 134 has a rounded or arcuate portion 42 at the first surface 36. Preferably, the arcuate portions 42 and 142 are smooth and continuous to avoid any sharp or blunt edges that could possibly damage the wire insulation as it passes through the opening 134 during the wire pulling and installation process.

Still referring to FIG. 10, a plurality of wires W, typically insulated, are shown extending through the opening 134 of the wire feed apparatus 130 and into the conduit C. The arrow D indicates the direction from which the wires W are being pulled as will be further explained below. Preferably, the height H of the extending portion 135 facilitates the guidance and position of the wires W as they enter the conduit C and connector C1.

Referring to FIG. 11, yet another embodiment of the wire feed apparatus, referred to as 300, is shown as a round member 332 having a plurality of paired opposing mounting apertures 344. The paired mounting apertures 344 are arcuate slots 346a and 346b, 348a and 348b, 350a and 350b, and 352a and 352b. Preferably, each pair of arcuate slots have a common radius of curvature R and are formed about a common point P. FIG. 11 identifies the radius of curvature R for arcuate slot 346b. It is to be understood that the paired arcuate slot 346a has the same radius of curvature R and arcuate slots 346a, 346b are formed about the common point P. It is also to be understood that while each of the other pairs of arcuate slots are formed about the common point P, each pair has its own radius of curvature. Preferably, each of the arcuate slots 346a, 346b, 348a, 348b, 350a, 350b, 352a and 352b include an enlarged portion 346a′, 346b′, 348a′, 348b′, 350a′, 350b′, 352a′ and 352b′, respectively, at one end of the arcuate slots. The enlarged portion 346a′, 346b′, 348a′, 348b′, 350a′, 350b′, 352a′ and 352b′ is larger than the head 24 of the screw 22 adapted to be received in the mounting aperture 344.

The wire feed apparatus 300 illustrated in FIG. 11 has four pairs of mounting apertures 344. Each pair of mounting apertures 344 have a unique spacing between the paired arcuate slots (for example, paired arcuate slots 346a and 346b) adapted to accommodate a particular screw spacing. Each unique spacing between the plurality of paired mounting apertures will facilitate mounting of the wire feed apparatus 300 on one or more types of boxes B. Still referring to FIG. 11, the wire feed apparatus 300 is shown having an opening, which for purposes of illustration and not limitation, is shown as the opening 134 having the extending portion 135 as described above with reference to the wire feed apparatus 130.

The wire feed apparatus 300 is adapted to be mounted to a box B without removing the screws 22 from the box B. For example, the wire feed apparatus 330 is mounted to a box B having a screw spacing corresponding to the spacing between paired mounting apertures 350a, 350b by aligning the enlarged portions 350a′, 350b′ with the box screw heads and positioning the wire feed apparatus 300 towards the box B so that the screw heads extend through the enlarged portions 350a′, 350b′. The wire feed apparatus 330 is then preferably rotated until the screws contact the opposite end of the arcuate slot 350a, 350b. The screws (shown in phantom) are then tightened to firmly secure the wire feed apparatus 300 to the box B.

The wire pulling and installation procedure is preferably accomplished using the wire feed apparatus of the present invention in conjunction with a wire pulling device, commonly referred to as a fish tape. Fish tapes for pulling wiring through conduits are well known in the industry as discussed in the “Background of the Invention.”

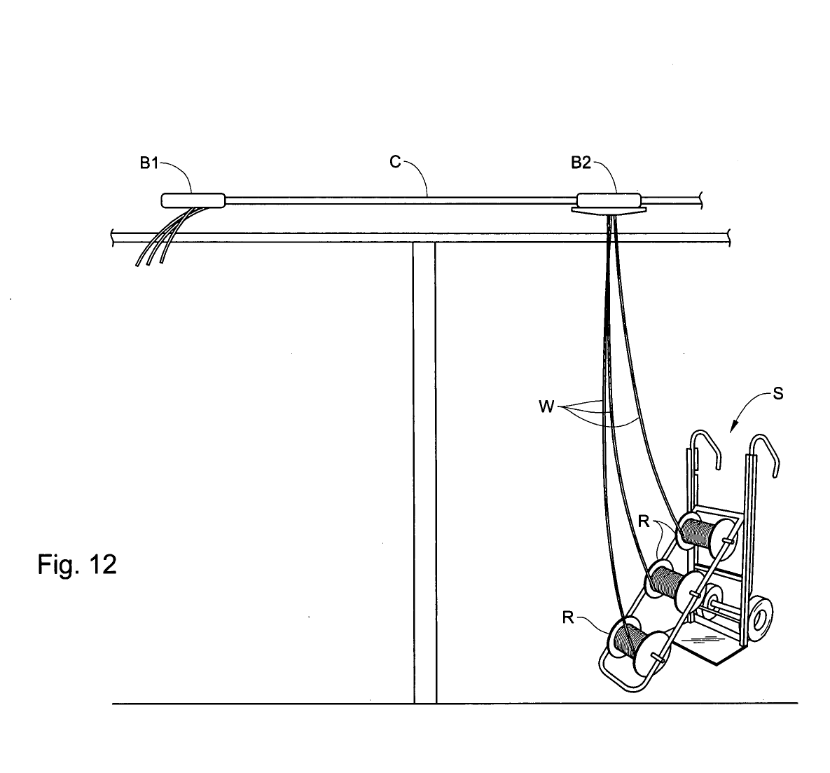

Initially, the wire feed apparatus of the present invention is easily and quickly attached to a box located at the “feed end” of the wire pull procedure, referenced as box B2 in FIG. 12. The wire feed apparatus is securely attached to box B2 in one of the manners described above for the various embodiments of the invention. For purposes of explanation, the remaining procedure will be described with reference to wire feed apparatus 130. The installer goes to the “pull end” and inserts an end of the fish tape (not shown) into a box B1 and forces the fish tape, typically made of resilient spring steel, through the conduit C and into the box B2. The end of the fish tape is retrieved through the wire feed apparatus opening 134 and the desired quantity of wires W are attached to the fish tape end in the usual manner. After the wires W have been attached to the fish tape end, the installer goes back to the pull end at box B1 and begins retrieving or pulling the fish tape with the attached wires W. Preferably, the wires W are on rotatably mounted reels R. As an example, FIG. 12 shows a prior art wire reel support device S rotatably supporting three reels R of wire W. As shown in FIG. 10, the opening 134 of the wire feed apparatus 130 provides guidance and limits the angle of entry of the wires W into the conduit C and conduit connector C1. Preferably, the opening 134 is substantially centrally located in the box B so that upon passing through the opening 134 the wires W have a suitable distance to become generally aligned with the conduit C before entering the conduit connector C1. This not only protects against marring or cutting the wire insulation during the installation, but also serves to reduce the required pulling force during wire installation.

It is to be understood that the wire feed apparatus is a compact device, preferably made of a durable, sturdy plastic, adapted to be attached to a box, typically an electrical box, and used in conjunction with a wire pulling tool to make it possible for one individual to pull electrical wiring, typically for outlets, fixtures, and other electrical devices, without the assistance of a second individual. It is also to be understood that the apparatus can be used for pulling various types of wires, including but not limited to, wires in the data/communication field.

As will be readily apparent to those skilled in the art, the present invention may easily be produced in other specific forms without departing from the spirit of the present invention. The disclosed embodiments are, therefore, to be considered as merely illustrative and not restrictive, the scope of the invention being indicated by the claims rather than the foregoing description, and all changes which come within the meaning and range of equivalence of the claims are therefore intended to be embraced therein.

1. A wire feed apparatus adapted for mounting to an electrical box of the type having a box opening defined by a peripheral wall and a pair of screws having screw heads, comprising:
a plate-like member having a first surface and a second surface, said member having at least one mounting aperture adapted for use in mounting said member to the box, and said member having an opening extending through said member, said opening defined by an arcuate wall from said first surface to said second surface.

2. The wire feed apparatus of claim 1, wherein said at least one mounting aperture comprises a first aperture and a second aperture, said first aperture comprising an elongated slot.

3. The wire feed apparatus of claim 2, wherein said second aperture comprises an elongated slot.

4. The wire feed apparatus of claim 1, wherein said opening is substantially centrally located in said member.

5. The wire feed apparatus of claim 4, wherein said at least one mounting aperture comprises a first aperture and a second aperture, said first aperture comprising a first elongated slot.

6. The wire feed apparatus of claim 5, wherein said second aperture comprises a second elongated slot.

7. The wire feed apparatus of claim 6, wherein said first and second elongated slots are axially aligned with each other.

8. The wire feed apparatus of claim 6, wherein each said elongated slot includes an enlarged portion through which the screw head of the box may pass.

9. The wire feed apparatus of claim 5, wherein said first elongated slot includes a portion for receiving one screw while the one screw is threadably engaged to the box.

10. The wire feed apparatus of claim 9, wherein said second elongated slot includes an enlarged portion through which the screw head of the second screw may pass.

11. The wire feed apparatus of claim 4, wherein said at least one mounting aperture comprises a first aperture and a second aperture, said first aperture comprising a first arcuate slot having an enlarged portion through which the screw head of the box may pass.

12. The wire feed apparatus of claim 11, wherein said second aperture comprises a second arcuate slot having an enlarged portion through which the screw head of the box may pass.

13. The wire feed apparatus of claim 12, wherein said first and second arcuate slots have a common radius of curvature and are formed about a common point.

14. The wire feed apparatus of claim 1, wherein said second surface is a substantially planer surface adapted to engage the peripheral wall of the box when said member is mounted to the box.

15. The wire feed apparatus of claim 1, wherein said member opening is circular and has a diameter in the range of 1.0″ to 1.75″.

16. The wire feed apparatus of claim 1, wherein said member opening has a height of at least 0.25″.

17. A wire feed apparatus adapted for mounting to an electrical box of the type having a box opening and a pair of screws having screw heads, comprising:
a plate-like member having a first mounting aperture and a second mounting aperture adapted for use in mounting said member to the box, and said member having an opening extending through said member, said opening having a height of at least 0.25″ and defined by a wall having an arcuate portion along the height of said opening.

18 The wire feed apparatus of claim 17, wherein said first and second apertures are elongated slots each having a length in the range of 1.0″ to 1.5″.

19. The wire feed apparatus of claim 17, wherein said wall defining said opening extends into the box opening in the range of 0.25″ to 0.75″ when said member is mounted to the box.

20. (canceled)
